(19) United States
(12) Patent Application Publication
(10) Pub. No.: US 2009/0174834 A1
(43) Pub. Date: Jul. 9, 2009

(54) LIQUID CRYSTAL DISPLAY AND METHOD OF FABRICATING THE SAME

(76) Inventors: Seung-Ha CHOI, Siheung-si (KR); Min-Seok Oh, Yongin-si (KR); Yu-Gwang Jeong, Yongin-si (KR); Hong-Kee Chin, Suwon-si (KR); Shin-II Choi, Seoul (KR); Sang-Gab Kim, Seoul (KR); Kap-Soo Yoon, Seoul (KR); Doo-Hee Jung, Seoul (KR)

Correspondence Address: Haynes and Boone, LLP;IP Section, 2323 Victory Avenue, SUITE 700, Dallas, TX, 75219, US

(21) Appl. No.: 12/188,934

(22) Filed: Aug. 8, 2008

(30) Foreign Application Priority Data
Jan. 7, 2008 (KR) 10-2008-0001784

(51) Int. Cl. G02F 1/1343; G02F 1/1368

(52) U.S. Cl. 349/46; 445/35

(57) ABSTRACT

One or more embodiments provide a liquid crystal display (LCD) including a thin-film transistor (TFT) with improved performance and a method of fabricating the LCD. In one embodiment, the LCD includes a gate electrode which is formed on an insulating substrate; an active layer which is formed on the gate electrode; an organic layer which is formed on the active layer and includes a first hole that exposes a source region and a second hole that exposes a drain region; a source electrode which fills the first hole; and a drain electrode which fills the second hole.

### CROSS-REFERENCE TO RELATED APPLICATION

This application claims priority to and benefit from Korean Patent Application No. 10-2008-0001784 filed on Jan. 7, 2008 in the Korean Intellectual Property Office, the disclosure of which is incorporated herein by reference in its entirety.

### BACKGROUND

1. Technical Field

Embodiments of the present invention generally relate to a liquid crystal display (LCD) and a method of fabricating the LCD, and, more particularly, to an LCD including a thin-film transistor (TFT) with improved performance and a method of fabricating the LCD.

2. Description of the Related Art

A liquid crystal display (LCD) includes a first substrate on which pixel electrodes are disposed, a second substrate on which common electrodes are disposed and a liquid crystal molecule layer having anisotropic dielectric properties which is interposed between the first and second substrates. An LCD generates an electric field between pixel electrodes and common electrodes, and adjusts the intensity of the electric field, thereby altering the arrangement of liquid crystal molecules in a liquid crystal molecule layer. In this manner, an LCD can control the amount of light transmitted through a liquid crystal molecule layer and can thus display a desired image. Thin-film transistors (TFTs) have been widely used as switching devices for LCDs.

A TFT includes a gate electrode, a drain electrode, a source electrode and an active layer. When a voltage having a predetermined magnitude or more is applied to the gate electrode, a current is applied to the active layer, and thus, a current flows between the drain electrode and the source electrode. The active layer may include amorphous silicon (a-Si) or polysilicon (p-Si).

However, as the size and resolution of LCDs has increased, the demand has steadily grown for LCDs including TFTs with improved performance, i.e., TFTs which can reduce the resistance of interconnection layers and can operate reliably even when the load of LCDs increases.

### SUMMARY

Embodiments of the present invention provide a liquid crystal display (LCD) having a thin-film transistor (TFT) with improved performance. Embodiments of the present invention also provide a method of fabricating an LCD having a TFT with improved performance.

However, the present invention according to one or more embodiments is not restricted to the ones set forth herein. The present invention according to one or more embodiments will become apparent to one of ordinary skill in the art to which the present invention pertains by referencing the detailed description of the embodiments of the present invention given below.

According to an aspect of an embodiment of the present invention, there is provided an LCD including a gate electrode which is formed on an insulating substrate; an active layer which is formed on the gate electrode; an organic layer which is formed on the active layer and includes a first hole that exposes a source region and a second hole that exposes a drain region; a source electrode which fills the first hole; and a drain electrode which fills the second hole.

According to another aspect of an embodiment of the present invention, there is provided a method of fabricating an LCD, the method including forming a gate electrode on an insulating substrate; forming an active layer on the gate electrode; forming an organic layer on the active layer, the organic layer including a first hole that exposes a source region and a second hole that exposes a drain region; and forming a source electrode and a drain electrode, the source electrode filling the first hole and the drain electrode filling the second hole.

According to another aspect of an embodiment of the present invention, there is provided an LCD including a gate electrode which is formed on an insulating substrate; an active layer which is formed on the gate electrode; a first buffer layer and a second buffer layer which are formed on the active layer and are spaced apart from each other; and a source electrode and a drain electrode which are formed on the first buffer layer and the second buffer layer, respectively, wherein the active layer is formed by an oxide semiconductor including one or more selected from the group consisting of Zn, In, Ga and Sn and the first buffer layer and the second buffer layer include indium zinc oxide (IZO) or indium tin oxide (ITO).

### BRIEF DESCRIPTION OF THE DRAWINGS

The above and other features and advantages of the embodiments of the present invention will become apparent by describing in detail the embodiments thereof with reference to the attached drawings in which:

FIGS. 1 through 12 illustrate cross-sectional views of a method of fabricating a liquid crystal display (LCD) according to an embodiment of the present invention;

FIGS. 13 through 15 illustrate cross-sectional views of a method of fabricating an LCD according to another embodiment of the present invention;

FIGS. 16 through 19 illustrate cross-sectional views of a method of fabricating an LCD according to another embodiment of the present invention; and

FIGS. 20 through 22 illustrate cross-sectional views of a method of fabricating an LCD according to another embodiment of the present invention.

### DETAILED DESCRIPTION

Embodiments of the present invention will now be described more fully with reference to the accompanying drawings, in which exemplary embodiments of the invention are shown. The invention may, however, be embodied in many different forms and should not be construed as being limited to the embodiments set forth herein. Rather, these embodiments are provided so that this disclosure will be thorough and complete, and will fully convey the concept of the invention to those skilled in the art. Like numbers refer to like elements throughout. As used herein the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Furthermore, relative terms such as “below,” “beneath,” or “lower,” “above,” and “upper” may be used herein to describe one element's relationship to another element as illustrated in the accompanying drawings. It will be understood that relative terms are intended to encompass different orientations of the device in addition to the orientation depicted in the accompanying drawings. For example, if the device in the accompanying drawings is turned over, elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the exemplary terms “below” and “beneath” can, therefore, encompass both an orientation of above and below.

Embodiments of the present invention will hereinafter be described in detail with reference to the accompanying drawings. In the drawings, a thin-film transistor region TFT in which a TFT is formed, a storage capacitor region in which a storage capacitor is formed, and a gate pad region in which a gate pad is formed, are illustrated all together.

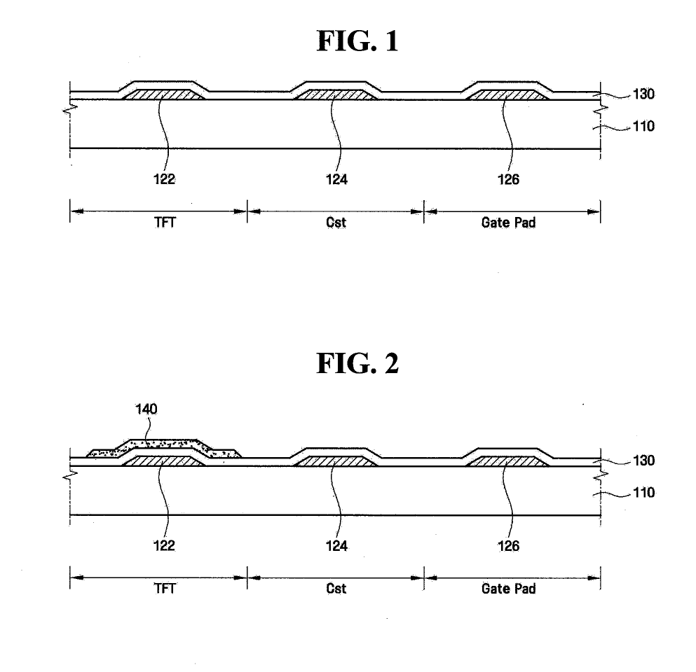

An LCD according to an embodiment of the present invention and a method of fabricating an LCD according to an embodiment of the present invention will hereinafter be described in detail with reference to FIGS. 1 through 12. FIGS. 1 through 12 illustrate cross-sectional views of a method of fabricating an LCD according to an embodiment of the present invention.

Referring to FIG. 1, a gate electrode 122, a storage electrode 124 and a gate pad 126 are formed on an insulating substrate 110. Thereafter, a dielectric layer 130 is formed on the insulating substrate 110. The insulating substrate 110 may include transparent glass or plastic.

The gate electrode 122, the storage electrode 124 and the gate pad 126 may be formed by depositing a metal layer on the insulating substrate 110 and patterning the metal layer. Specifically, the metal layer may be formed on the insulating substrate 110 using a physical vapor deposition (PVD) method. The metal layer may be a single layer or a double layer including copper (Cu), molybdenum (Mo), aluminum (Al), silver (Ag), titanium (Ti), niobium (Nb), tungsten (W), chromium (Cr), tantalum (Ta) or an alloy thereof. For example, the metal layer may be a single layer including Ag, Cu, or Mo.

Thereafter, a photolithography operation may be performed using a first mask (not shown). That is, photoresist is applied on the metal layer, and exposure and development operations may be performed on the photoresist. Then, the metal layer may be partially etched, thereby completing the formation of the gate electrode 122, the storage electrode 124 and the gate pad 126.

Thereafter, the dielectric layer 130 is formed on the insulating substrate 110 on which the gate electrode 122, the storage electrode 124 and the gate pad 126 are formed. The dielectric layer 130 may include silicon oxide, silicon nitride, silicon oxynitride or a combination thereof. The dielectric layer 130 may be formed using a chemical vapor deposition (CVD) method.

Thereafter, referring to FIG. 2, an active layer 140 is formed on the gate electrode 122. The active layer 140 may be formed by depositing an oxide semiconductor layer and patterning the oxide semiconductor layer. The oxide semiconductor layer may include an oxide semiconductor containing one or more selected from the group consisting of zinc (Zn), indium (In), gallium (Ga), and stannum (Sn).

Thereafter, a photolithography operation may be performed using a second mask (not shown). That is, photoresist is applied on the oxide semiconductor layer, and exposure and development operations are performed on the photoresist. Thereafter, the oxide semiconductor layer is partially etched, thereby completing the formation of the active layer 140.

The oxide semiconductor layer may be etched using a dry etching method or a wet etching method. Specifically, the oxide semiconductor layer may be etched using a dry etching method by using trifloromethane CHF₃, methane CF₄, a mixed gas of CHF₃ and either argon (Ar) or helium (He) or a mixed gas of CF₄ and either Ar or He as an etching gas. Alternatively, the oxide semiconductor layer may be etched using a wet etching method by using a diluted hydrofluoric acid (HF) solution, a phosphoric acid solution, a nitric acid solution, an acetic acid solution, a sulfuric acid solution or a hydrochloric acid solution.

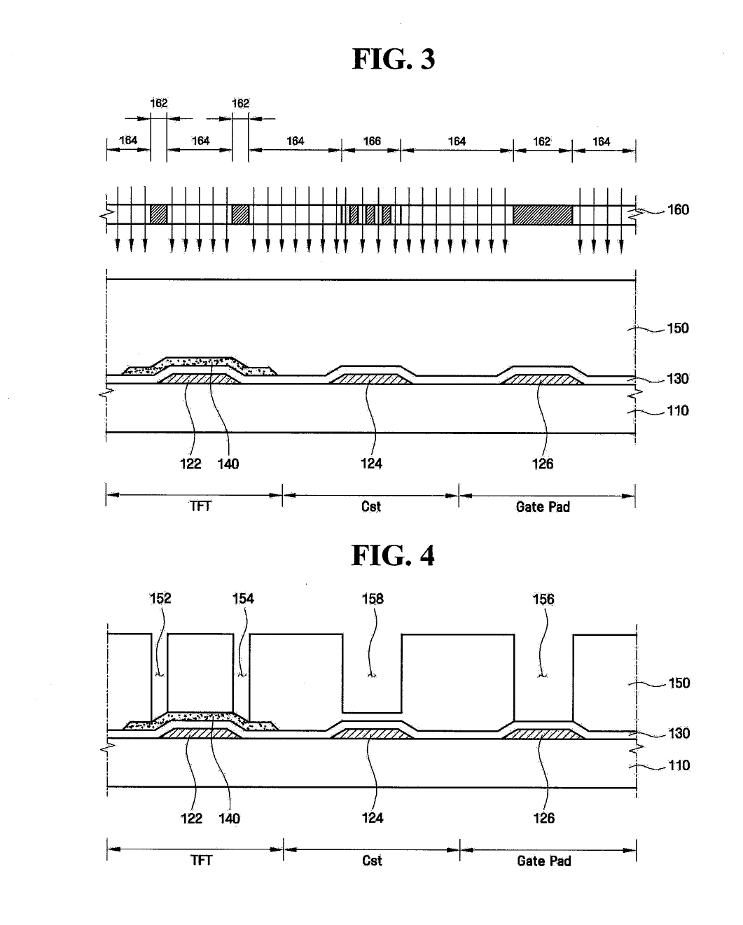

Thereafter, referring to FIG. 3, an organic layer 150 having photosensitivity is formed, and a photolithography operation is performed on the organic layer 150 using a third mask 160 having a plurality of slits.

The organic layer 150 may include a material having excellent planarization properties. The organic layer 150 may have negative photosensitivity which makes it possible to precisely pattern the organic layer 150.

Thereafter, in order to form organic layer patterns having different thicknesses, exposure and development operations may be performed on the organic layer 150 using the third mask 160. The third mask 160 includes transparent regions 164, shield regions 162 and a semi-transmissive region 166 in which the slits of the third mask 160 are formed. Since the third mask 160 has a plurality of slits, it is possible to vary the thickness of the organic layer 150 from one portion to another by using the third mask 160.

Alternatively, a photolithography operation may be performed on the organic layer 150 using a third mask having a semi-transparent portion, i.e., a halftone mask, instead of using the third mask 160.

Thereafter, referring to FIG. 4, a first hole 152, a second hole 154, a gate pad hole 156 and a storage capacitor hole 158 are formed in the organic layer 150. The first hole 152 exposes a source region, and the second hole 154 exposes a drain region. The gate pad hole 156 is formed in a gate pad region “Gate Pad,” and the storage capacitor hole 158 is formed in a storage capacitor region “Cst.”

Specifically, a patterning operation is performed using as a patterning mask the organic layer 150 resulting from the photolithography operation described above with reference to FIG. 3. The patterning operation may be performed using a 0.4% tetramethyl ammonium hydroxide (TMAH) solution as an etchant. In this case, it is possible to reduce damage to the active layer 140, which comprises an oxide semiconductor including one or more selected from the group consisting of of Zn, In, Ga, and Sn.

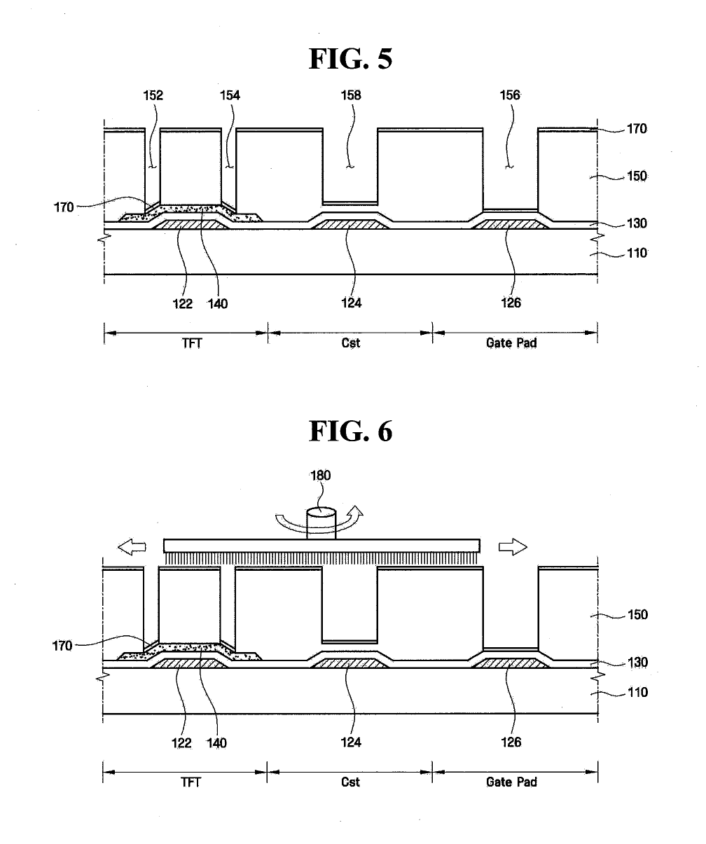

Thereafter, referring to FIG. 5, a seed layer 170 is formed on the organic layer 150 and in the first hole 152, the second hole 154, the gate pad hole 156 and the storage capacitor hole 158, respectively. The seed layer 170 may include Mo, which is a catalyst metal. The seed layer 170 and a catalyst metal will be described later in further detail.

Thereafter, referring to FIG. 6, a chemical mechanical polishing (CMP) operation 180 is performed such that the seed layer 170 may only remain in the first and second holes 152 and 154, the storage capacitor hole 158 and the gate pad hole 156.

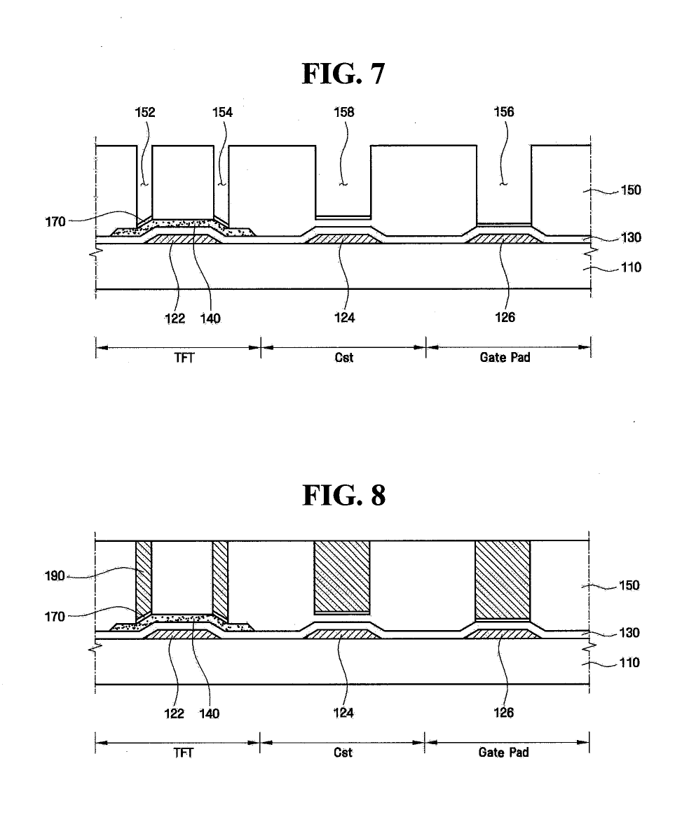

As a result of the CMP operation 180, no seed layer remains on the top surface of the organic layer 150, as illustrated in FIG. 7. That is, referring to FIG. 7, the seed layer 170 only remains in the first and second holes 152 and 154, the storage capacitor hole 158 and the gate pad hole 156.

Thereafter, referring to FIG. 8, the first and second holes 152 and 154, the storage capacitor hole 158 and the gate pad hole 156 are filled with a conductive material 190 using an electroless plating (ELP) method. The conductive material 190 that fills the first hole 152 becomes a source electrode 192 of FIG. 12, and the conductive material 190 that fills the second hole 154 becomes a drain electrode 194 of FIG. 12.

ELP is a type of plating method involving the use of a catalyst metal and an aqueous solution, which contains metal ions and a reducing agent, without the need to apply electric energy. The conductive material 190 originates from metal ions in an aqueous solution containing metal ions and a reducing agent. Specifically, the seed layer 170 is formed of a catalyst metal in the first hole 152, the second hole 154, the gate pad hole 156 and the storage capacitor hole 158, and an aqueous solution containing metal ions and a reducing agent that is applied to the seed layer 170. Then, the reducing agent in the aqueous solution supplies electrons to the metal ions in the aqueous solution so that the metal ions may be reduced into metal molecules, and may then be extracted from the bottom surfaces of the first hole 152, the second hole 154, the gate pad hole 156 and the storage capacitor hole 158. If the seed layer 170 includes, for example, Mo, the conductive material 190 may include a metal such as Cu.

By using ELP, it is possible to densely fill the first hole 152, the second hole 154, the gate pad hole 156 and the storage capacitor hole 158 with the conductive material 190 and to form source and drain electrodes 192 and 194 having a thickness of 1 um or more.

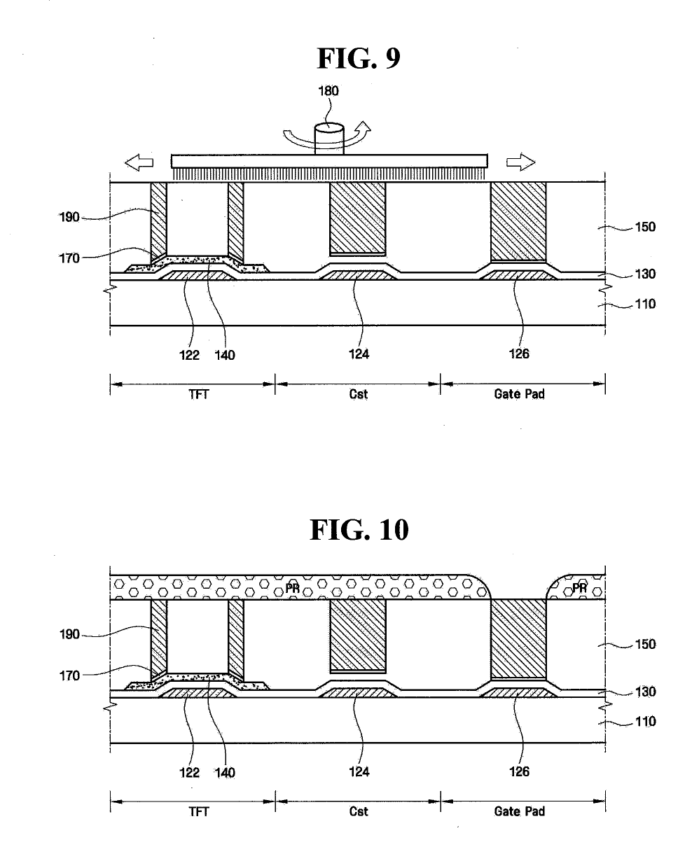

Thereafter, referring to FIG. 9, a CMP operation is performed on the organic layer 150 so that the organic layer 150 may be planarized, and so that the source electrodes 192 (shown in FIG. 12) and the drain electrodes 194 whose surfaces may have been irregular due to ELP may be planarized along with the organic layer 150.

Thereafter, referring to FIG. 10, a photolithography operation may be performed using a fourth mask (not shown). That is, photoresist PR is applied on the organic layer 150, and exposure and development operations are performed on the photoresist PR. Specifically, the photoresist PR may be deposited on the entire surface of the insulating substrate 110, except for the conductive material 190 on the gate pad 126.

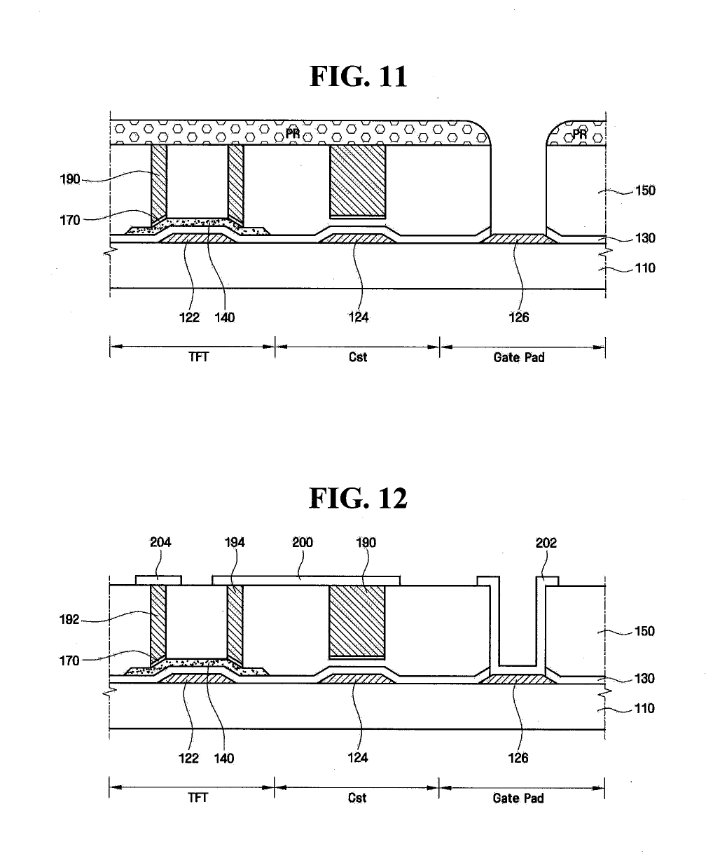

Thereafter, referring to FIG. 11, the conductive material 190 and a portion of the dielectric layer 130 that are not covered with the photoresist PR are removed. Specifically, the conductive material 190 on the gate pad 126 is etched. During the etching of the conductive material 190 on the gate pad 126, the seed layer 170 may also be etched.

During the etching of the conductive material 190 on the gate pad 126, an etchant containing phosphoric acid, nitric acid, acetic acid, hydrochloric acid, or sulfuric acid may be used to etch the conductive material 190 on the gate pad 126 if, according to an embodiment, the corresponding conductive material 190 includes Ag or Cu. Alternatively, an aluminum (Al) etchant may be used to etch the conductive material 190 on the gate pad 126 if, according to another embodiment, the corresponding conductive material 190 includes Mo or Al.

Thereafter, a portion of the dielectric layer 130 on the gate pad 126 is etched. The dielectric layer 130 may be etched using a dry etching method. For example, the dielectric layer 130 may be etched using a dry etching method and using a chlorine (Cl₂)— and oxygen (O₂)-based gas or a sulfur hexafluoride (SF6)- and O₂-based gas as an etching gas.

Thereafter, referring to FIG. 12, a conductive layer (not shown) for forming a pixel electrode is deposited and patterned, thereby forming a data pad 204, a pixel electrode 200 and an auxiliary gate pad 202. The data pad 204 is connected to the source electrode 192. The pixel electrode 200 is disposed on a level with the data pad 204 and is connected to the drain electrode 194.

The conductive layer for forming a pixel electrode may include a transparent conductive layer having an amorphous or partially amorphous structure. For example, the conductive layer for forming a pixel electrode may include amorphous-indium tin oxide (a-ITO), amorphous-indium zinc oxide (a-IZO) or ITO obtained by deposition performed at a temperature of 200° C. or lower.

Thereafter, a photolithography operation is performed using a fifth mask (not shown). That is, photoresist is applied on the conductive layer for forming a pixel electrode, and exposure and development operations are performed on the photoresist. Thereafter, the conductive layer for forming a pixel electrode is partially etched, thereby completing the formation of the data pad 204, the pixel electrode 200 and the auxiliary gate pad 202.

The pixel electrode 200 may be connected to the conductive material 190 in the storage capacitor Cst. The pixel electrode 200, which is connected to the conductive material 190 in the storage capacitor region Cst, and the storage electrode 124 may constitute a storage capacitor having the dielectric layer 130 and the organic layer 150 as dielectric materials.

The auxiliary gate pad 202 is formed on the gate pad 126 on a level with the data pad 204 and is connected to the gate pad 126. A gate signal may be applied to the auxiliary gate pad 202. Then, the gate signal is transmitted to the gate electrode 122 through the gate pad 126 and a gate line (not shown).

The embodiments of FIGS. 1 through 12 may have the following advantages.

First, in the embodiments of FIGS. 1 through 12, the drain electrode 194 and the source electrode 192 are formed of a conductive material by using an ELP method. Therefore, it is possible to form source and drain electrodes having a thickness of 1 um or more, and it is possible to increase the thickness of interconnection layers connected to the source and drain electrodes. Thus it is possible to reduce the resistance of interconnection layers of an LCD.

Second, in the embodiments of FIGS. 1 through 12, the active layer 140 comprises an oxide semiconductor including one or more selected from the group consisting of Zn, In, Ga, and Sn. Thus, it is possible to improve the performance of a TFT and thereby to enable a TFT to operate reliably even when the load of an LCD increases. Specifically, it is possible to improve the field effect mobility of the active layer 140 and provide a TFT having excellent switching properties such as an “on/off” current ratio of 10⁵-10⁷.

In the embodiments of FIGS. 1 through 12, the active layer 140 includes an oxide semiconductor including one or more selected from the group consisting of Zn, In, Ga and Sn. Examples of the oxide semiconductor include ZnO, InGaZnO₄, Zn—In—O, and Zn—Sn—O, which can provide 10-100 times greater field effect mobility than hydrogenated amorphous silicon (a-Si:H). For example, an oxide semiconductor mixed with In₂O₃, Ga₂O₃, or ZnO having an amorphous structure can provide 20 times greater field effect mobility than dehydrogenated amorphous silicon (a-Si). ZnO, in particular, can provide a field effect mobility of up to 200 cm²/V·s, which is comparable to that of polysilicon (p-Si).

Thereafter, according to one or more embodiments of FIGS. 1 through 12, it is possible to improve the uniformity of the properties of TFTs, compared to a TFT having an active layer formed of p-Si. Specifically, the active layer 140 may be formed of p-Si by depositing a-Si using a CVD method, performing dehydrogenation, performing laser crystallization using, for example, a laser annealing method, and implanting impurity ions such as boron (B). However, it is difficult to uniformly form the active layer 140 of p-Si on the insulating substrate 110. If the active layer 140 is not uniformly formed on the insulating substrate 110, TFTs may have different properties.

In the embodiments of FIGS. 1 through 12, the active layer 140 comprises an oxide semiconductor including one or more selected from the group consisting of Zn, In, Ga, and Sn, and the oxide semiconductor has an amorphous structure. Thus, it is possible to improve the uniformity of the active layer 140, and thereby to improve the uniformity of the properties of TFTs.

An LCD according to another embodiment of the present invention and a method of fabricating an LCD according to another embodiment of the present invention will hereinafter be described in detail with reference to FIGS. 1, 2, 5 through 11 and 13 through 15.

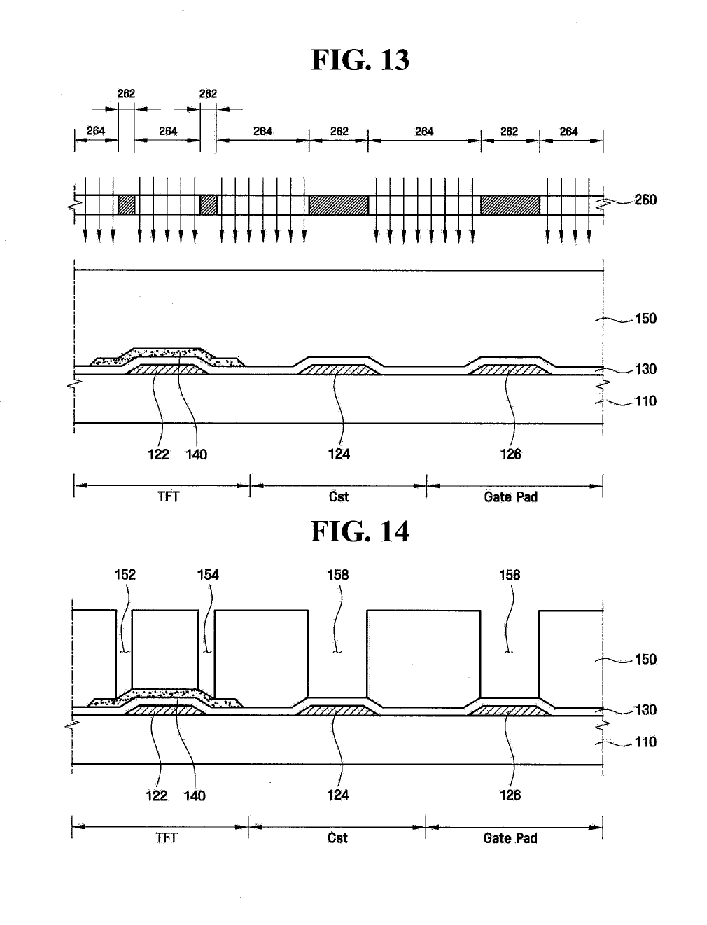

FIGS. 13 through 15 illustrate cross-sectional views for explaining a method of fabricating an LCD according to another embodiment of the present invention. In FIGS. 1 through 15, like reference numerals indicate like elements, and thus, detailed descriptions thereof will be skipped. For convenience, the embodiment of FIGS. 13 through 15 will hereinafter be described, mainly focusing on the differences with respect to the embodiment of FIGS. 1 through 12.

Referring to FIG. 1, a gate electrode 122, a storage electrode 124 and a gate pad 126 are formed on an insulating substrate 110, and then a dielectric layer 130 is formed on the insulating substrate 110.

Thereafter, referring to FIG. 2, an active layer 140 is formed on the gate electrode 122. Specifically, the active layer 140 may be formed by depositing an oxide semiconductor layer and patterning the oxide semiconductor layer.

Thereafter, referring to FIG. 13, an organic layer 150 having photosensitivity is formed, and a photolithography operation is performed on the organic layer 150 using a third mask 260. The third mask 260 in this embodiment, unlike the third mask 160 illustrated in the embodiment of FIG. 3, only includes shield units 262 and transmissive units 264, but does not include slits or semi-transmissive units.

Thereafter, referring to FIG. 14, a first hole 152, a second hole 154, a gate pad hole 156, and a storage capacitor hole 158 are formed in the organic layer 150. The first hole 152 exposes a source region. The second hole 154 exposes a drain region. The gate pad hole 156 is formed in a gate pad region “Gate Pad.” The storage capacitor hole 158 is formed in a storage capacitor region “Cst.” In the embodiment of FIGS. 13 through 15, unlike in the embodiment of FIGS. 1 through 12, the storage capacitor hole 158 is formed through the organic layer 150 so that the dielectric layer 130 may be exposed through the storage capacitor hole 158.

Thereafter, referring to FIG. 5, a seed layer 170 is formed on the organic layer 150 and in the first hole 152, the second hole 154, the gate pad hole 156 and the storage capacitor hole 158, respectively.

Thereafter, referring to FIG. 6, a chemical mechanical polishing (CMP) operation 180 is performed such that the seed layer 170 may only remain in the first and second holes 152 and 154, the storage capacitor hole 158 and the gate pad hole 156.

As a result of the CMP operation 180, no seed layer remains on the top surface of the organic layer 150, as illustrated in FIG. 7.

Thereafter, referring to FIG. 8, the first and second holes 152 and 154, the storage capacitor hole 158 and the gate pad hole 156 are filled with a conductive material 190 using an ELP method.

Thereafter, referring to FIG. 9, a CMP operation is performed on the organic layer 150 so that the organic layer 150 may be planarized.

Thereafter, referring to FIG. 10, a photolithography operation is performed using a fourth mask (not shown).

Thereafter, referring to FIG. 11, a conductive material 190 and a portion of the dielectric layer 130 that are not covered with photoresist PR are removed.

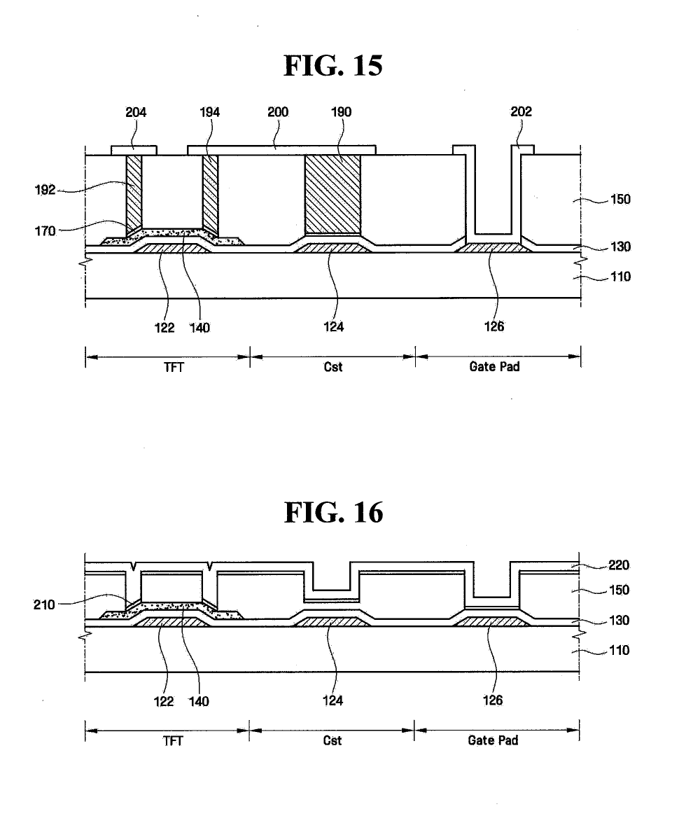

Thereafter, referring to FIG. 15, a conductive layer for forming a pixel electrode is deposited and patterned, thereby forming a data pad 204, a pixel electrode 200 and an auxiliary gate pad 202. The data pad 204 is connected to a source electrode 192. The pixel electrode 200 is disposed on a level with the data pad 204 and is connected to a drain electrode 194. The auxiliary gate pad 202 is connected to the gate pad 126.

The embodiment of FIGS. 13 through 15 may have the following advantages.

First, according to the embodiment of FIGS. 13 through 15, it is possible to reduce the resistance of interconnection layers of an LCD.

Second, in the embodiment of FIGS. 13 through 15, the active layer 140 may comprise an oxide semiconductor including one or more selected from the group consisting of Zn, In, Ga, and Sn. Thus, it is possible to improve the performance of a TFT.

Third, in the embodiment of FIGS. 13 through 15, only the dielectric layer 130 is interposed between the storage electrode 124 and the pixel electrode 200, whereas in the embodiment of FIGS. 1 through 12, the dielectric layer 130 and the organic layer 150 are both interposed between the storage electrode 124 and the pixel electrode 200. Thus, in the embodiment of FIGS. 13 through 15, only the dielectric layer 130 serves as a dielectric material that generates storage capacitance between the storage electrode 124 and the pixel electrode 200. Accordingly, it is possible to further increase the storage capacitance relative to the embodiment of FIGS. 1 through 12. Therefore, the embodiment of FIGS. 13 through 15 may be suitable for use in LCDs that require a high voltage holding ratio (VHR).

An LCD according to another embodiment of the present invention and a method of fabricating an LCD according to another embodiment of the present invention will hereinafter be described in detail with reference to FIGS. 1 through 4 and 16 through 19.

FIGS. 16 through 19 illustrate cross-sectional views for explaining a method of fabricating an LCD according to another embodiment of the present invention. In FIGS. 1 through 19, like reference numerals indicate like elements, and thus, detailed descriptions thereof will be skipped. For convenience, the embodiment of FIGS. 16 through 19 will hereinafter be described, mainly focusing on the differences with respect to the embodiment of FIGS. 1 through 12.

Referring to FIG. 1, a gate electrode 122, a storage electrode 124 and a gate pad 126 are formed on an insulating substrate 110, and then a dielectric layer 130 is formed on the insulating substrate 110. Each of the gate electrode 122, the storage electrode 124 and the gate pad 126 may include a triple layer of IZO/Ag/IZO or ITO/Ag/ITO.

Specifically, if each of the gate electrode 122, the storage electrode 124 and the gate pad 126 includes a single layer of silver (Ag), the gate electrode 122, the storage electrode 124 and the gate pad 126 may have poor contact properties. In order to address this, each of the gate electrode 122, the storage electrode 124 and the gate pad 126 may include an IZO or ITO layer which is formed on the insulating substrate 110 and an Ag layer which is formed on the IZO or ITO layer. In order to further improve the contact properties of the gate electrode 122, the storage electrode 124 and the gate pad 126, each of the gate electrode 122, the storage electrode 124 and the gate pad 126 may also include another IZO or ITO layer which may be formed on the Ag layer.

Thereafter, referring to FIG. 2, an active layer 140 is formed on the gate electrode 122. Specifically, the active layer 140 may be formed by depositing an oxide semiconductor layer and patterning the oxide semiconductor layer.

Thereafter, referring to FIG. 3, an organic layer 150 having photosensitivity is formed, and a photolithography operation is performed on the organic layer 150 using a third mask 160 having a plurality of slits.

Thereafter, referring to FIG. 4, a first hole 152, a second hole 154, a gate pad hole 156 and a storage capacitor hole 158 are formed in the organic layer 150. The first hole 152 exposes a source region, and the second hole 154 exposes a drain region. The gate pad hole 156 is formed in a gate pad region “Gate Pad,” and the storage capacitor hole 158 is formed in a storage capacitor region “Cst.”

Thereafter, referring to FIG. 16, a conductive layer 210 for forming a buffer layer is formed, and a metal layer 220 is formed on the conductive layer 210.

The conductive layer 210 may include a transparent conductive layer having an amorphous structure or a partially amorphous structure. For example, the conductive layer 210 may include a-ITO, a-IZO or ITO obtained by deposition performed at a temperature of 200□ or lower.

The metal layer 220 may be formed using a PVD method. The metal layer 220 may include a single layer which is formed of Cu, Mo, Al, Ag, Ti, Nb, W, Cr, Ta or an alloy thereof. Specifically, the metal layer 220 may include Ag.

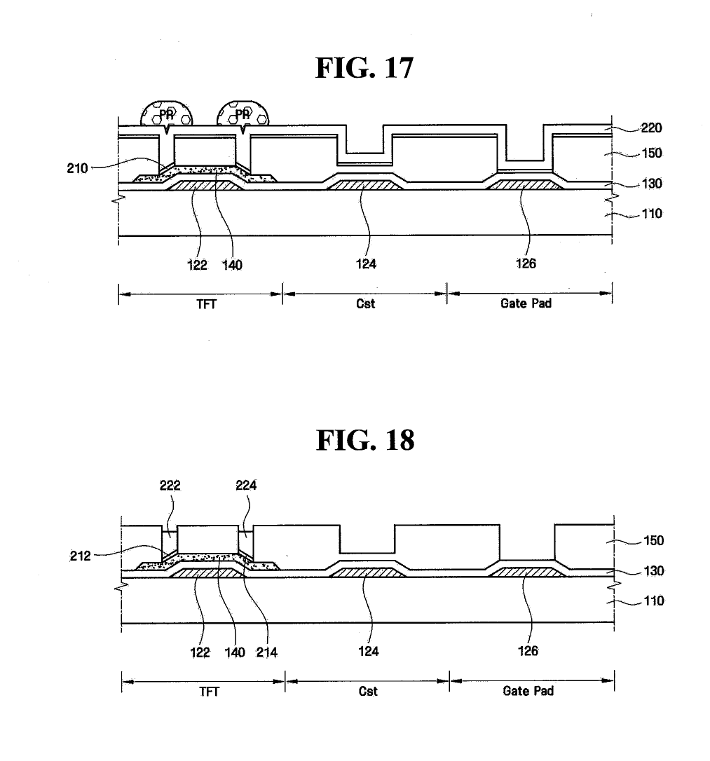

Thereafter, referring to FIG. 17, a photolithography operation is performed using a fourth mask (not shown). That is, photoresist PR is applied on the metal layer 220, and exposure and development operations are performed on the photoresist PR.

Thereafter, referring to FIG. 18, a first buffer layer 212, a second buffer layer 214, a source electrode 222 and a drain electrode 224 are formed. The first and second buffer layers 212 and 214 are disposed on the active layer 140 and are spaced apart from each other. The source electrode 222 is disposed on the first buffer layer 212, and the drain electrode 224 is disposed on the second buffer layer 214. If the metal layer 220 (shown in FIG. 17) includes Ag, the source and drain electrodes 222 and 224 may also include Ag.

Specifically, portions of the conductive layer 210 and the metal layer 220 that are not covered with the photoresist PR may be etched using a wet etching method and using an etchant that can etch both the conductive layer 210 and the metal layer 220 at the same time.

The whole active layer 140 except for portions on which the first and second buffer layers 212 and 214 are formed is covered by the organic layer 150. Thus, the active layer 140, which comprises an oxide semiconductor including one or more selected from the group consisting of Zn, In, Ga and Sn, may be protected by the organic layer 150 during a wet etching operation for forming the first buffer layer 212, the second buffer layer 214, the source electrode 222 and the drain electrode 224.

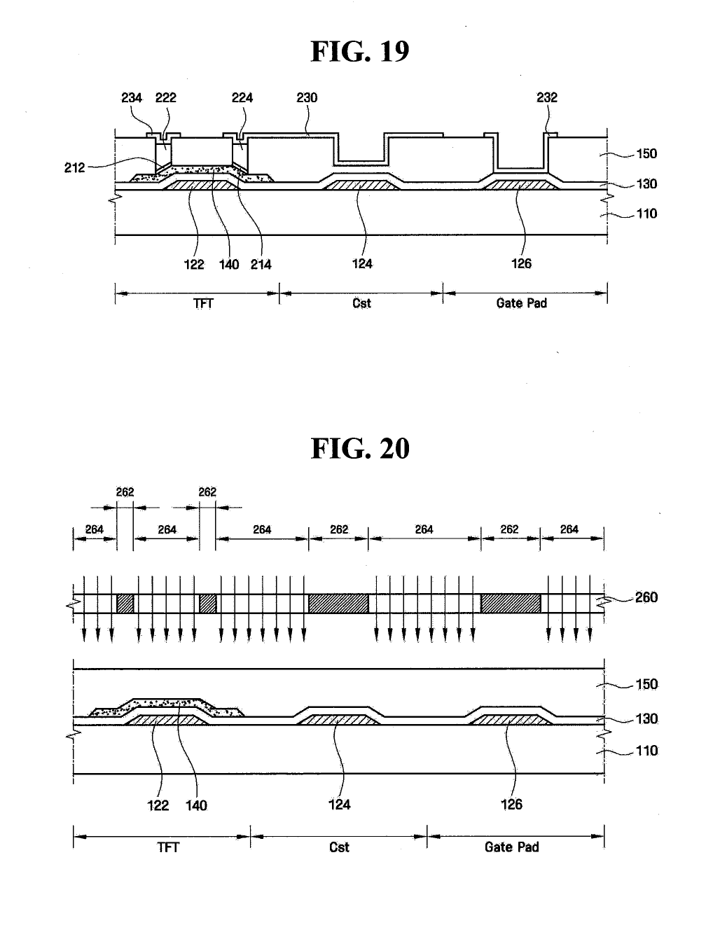

Thereafter, referring to FIG. 19, a conductive layer (not shown) for forming a pixel electrode is deposited and patterned, thereby forming a data pad 234, a pixel electrode 230 and an auxiliary gate pad 232. The data pad 234 is connected to the source electrode 222. The pixel electrode 230 is disposed on a level with the data pad 234 and is connected to the drain electrode 224. The auxiliary gate pad 232 is formed on the gate pad 126 on a level with the data pad 234 and is connected to the gate pad 126.

The embodiment of FIGS. 16 through 19 may have the following advantages.

In the embodiment of FIGS. 16 through 19, the source electrode 222 and the drain electrode 224 may include Ag. If each of the source electrode 222 and the drain electrode 224 includes a single layer of Ag, the source electrode 222 and the drain electrode 224 may have poor contact properties. In the embodiment of FIGS. 16 through 19, in order to address this, the first and second buffer layers 212 and 214 may be formed of IZO or ITO having excellent contact properties. Therefore, it is possible to provide excellent contact properties.

If the active layer 140 includes a-Si, an ohmic contact may not be formed between the active layer 140 and the source electrode 222 or between the active layer 140 and the drain electrode 224. This problem may be addressed by forming the active layer 140 of an oxide semiconductor including one or more selected from the group consisting of Zn, In, Ga and Sn, as performed in the embodiment of FIGS. 16 through 19.

As described above in the embodiment of FIGS. 16 through 19, the drain electrode 224, the source electrode 222 and the interconnection layers connected to the drain electrode 224 and the source electrode 222 may be formed of Ag having a low resistance. Thus, it is possible to reduce the resistance of the interconnection layers of an LCD.

In addition, in the embodiment of FIGS. 16 through 19, like in the embodiment of FIGS. 1 through 12, the active layer 140 comprises an oxide semiconductor including one or more selected from the group consisting of Zn, In, Ga and Sn. Thus, it is possible to improve the performance of a TFT.

An LCD according to another embodiment of the present invention and a method of fabricating an LCD according to another embodiment of the present invention will hereinafter be described in detail with reference to FIGS. 1, 2 17, 18 and 20 through 22.

FIGS. 20 through 22 illustrate cross-sectional views for explaining a method of fabricating an LCD according to another embodiment of the present invention. In FIGS. 1 through 22, like reference numerals indicate like elements, and thus, detailed descriptions thereof will be skipped. For convenience, the embodiment of FIGS. 20 through 22 will hereinafter be described, mainly focusing on the differences with respect to the embodiment of FIGS. 16 through 19.

Referring to FIG. 1, a gate electrode 122, a storage electrode 124 and a gate pad 126 are formed on an insulating substrate 110, and then a dielectric layer 130 is formed on the insulating substrate 110.

Thereafter, referring to FIG. 2, an active layer 140 is formed on the gate electrode 122. Specifically, the active layer 140 may be formed by depositing an oxide semiconductor layer and patterning the oxide semiconductor layer.

Thereafter, referring to FIG. 20, an organic layer 150 having photosensitivity is formed, and a photolithography operation is performed on the organic layer 150 using a third mask 260. The third mask 260 in this embodiment, unlike the third mask 160 illustrated in the embodiment of FIG. 3, only includes shield units 262 and transmissive units 264, but does not include slits or semi-transmissive units.

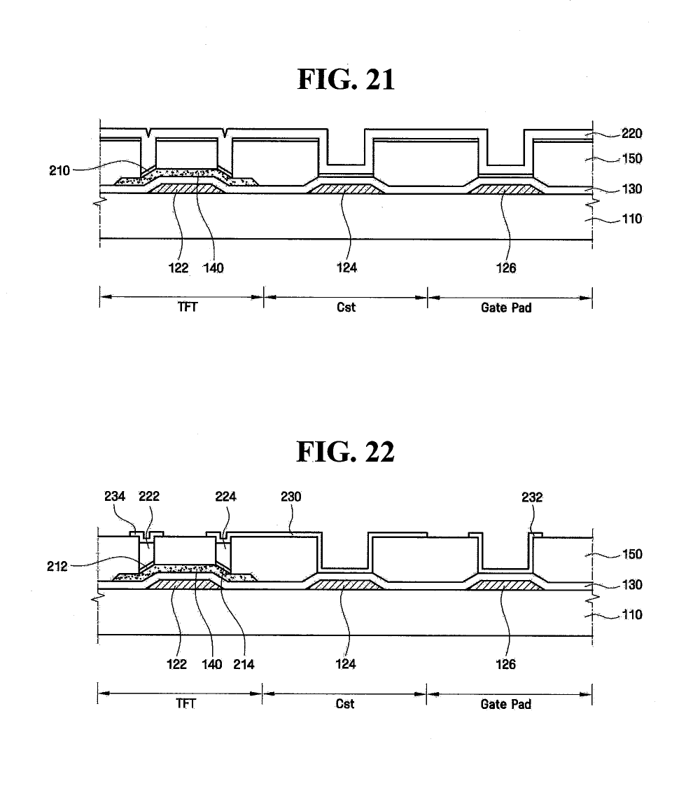

Thereafter, referring to FIG. 21, a first hole, a second hole, a gate pad hole and a storage capacitor hole are formed in the organic layer 150. The first hole exposes a source region. The second hole exposes a drain region. The gate pad hole is formed in a gate pad region “Gate Pad.” The storage capacitor hole is formed in a storage capacitor region “Cst.” In the embodiment of FIGS. 20 through 22, unlike in the embodiment of FIGS. 1 through 12, the storage capacitor hole is formed through the organic layer 150 so that the dielectric layer 130 can be exposed through the storage capacitor hole. Thereafter, a conductive layer 210 for forming a buffer layer is formed, and a metal layer 220 is formed.

Thereafter, referring to FIG. 17, a photolithography operation is performed using a fourth mask (not shown). That is, photoresist is applied on the insulating substrate 110, and exposure and development operations are performed on the photoresist.

Thereafter, referring to FIG. 18, a first buffer layer 212, a second buffer layer 214, a source electrode 222 and a drain electrode 224 are formed.

Thereafter, referring to FIG. 22, a conductive layer (not shown) for forming a pixel electrode is deposited and patterned, thereby forming a data pad 234, a pixel electrode 230 and an auxiliary gate pad 232. The data pad 234 is connected to the source electrode 222. The pixel electrode 230 is disposed on a level with the data pad 234 and is connected to the drain electrode 224. The auxiliary gate pad 232 is formed on the gate pad 126 on a level with the data pad 234 and is connected to the gate pad 126.

The embodiment of FIGS. 20 through 22 may have the following advantages.

First, according to the embodiment of FIGS. 20 through 22, it is possible to reduce the resistance of interconnection layers of an LCD.

Second, in the embodiment of FIGS. 20 through 22, the active layer 140 may comprise an oxide semiconductor including one or more selected from the group consisting of Zn, In, Ga, and Sn. Thus, it is possible to improve the performance of a TFT.

Third, in the embodiment of FIGS. 20 through 22, only the dielectric layer 130 is interposed between the storage electrode 124 and the pixel electrode 230, whereas, in the embodiment of FIGS. 16 through 19, the dielectric layer 130 and the organic layer 150 are both interposed between the storage electrode 124 and the pixel electrode 230. Thus, in the embodiment of FIGS. 20 through 22, only the dielectric layer 130 serves as a dielectric material that generates storage capacitance between the storage electrode 124 and the pixel electrode 230. Accordingly, it is possible to further increase storage capacitance in this embodiment than in the embodiment of FIGS. 16 through 19. Therefore, the embodiment of FIGS. 20 through 22 may be suitable for use in LCDs that require a high voltage-holding ratio (VHR).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A liquid crystal display (LCD) comprising:
a gate electrode which is formed on an insulating substrate;
an active layer which is formed on the gate electrode;
an organic layer which is formed on the active layer and includes a first hole that exposes a source region and a second hole that exposes a drain region;
a source electrode which fills the first hole; and
a drain electrode which fills the second hole.

2. The LCD of claim 1, further comprising:
a data pad which is formed on the organic layer and is connected to the source electrode; and
a pixel electrode which is formed on a level with the data pad and is connected to the drain electrode.

3. The LCD of claim 1, wherein the source electrode and the drain electrode are formed by forming a seed layer in the first and second holes, respectively, and filling the first and second holes with a conductive material by performing electroless plating.

4. The LCD of claim 3, wherein the seed layer includes molybdenum (Mo) catalyst and the conductive material includes copper (Cu).

5. The LCD of claim 1, wherein the organic layer has negative photosensitivity and the first and second holes are formed by performing patterning using the organic layer as a patterning mask.

6. The LCD of claim 1, wherein the active layer is formed by an oxide semiconductor including one or more selected from the group consisting of zinc (Zn), indium (In), gallium (Ga) and stannum (Sn).

7. The LCD of claim 1, wherein the source electrode and the drain electrode have a thickness of 1 um or more.

8. A method of fabricating an LCD, the method comprising:
forming a gate electrode on an insulating substrate;
forming an active layer on the gate electrode;
forming an organic layer on the active layer, the organic layer including a first hole that exposes a source region and a second hole that exposes a drain region; and
forming a source electrode and a drain electrode, the source electrode filling the first hole and the drain electrode filling the second hole.

9. The method of claim 8, further comprising:
forming a data pad and a pixel electrode on the organic layer, after the forming the source electrode and the drain electrode,
wherein the data pad is connected to the source electrode, and wherein the pixel electrode is formed on a level with the data pad and is connected to the drain electrode.

10. The method of claim 8, wherein the forming of the source electrode and the drain electrode comprises forming a seed layer in the first and second holes, respectively, and filling the first and second holes with a conductive material by performing electroless plating.

11. The method of claim 10, wherein the forming of the seed layer in the first and second holes comprises forming the seed layer on the organic layer and performing chemical mechanical polishing (CMP) so that the seed layer may only remain in the first and second holes.

12. The method of claim 8, further comprising: planarizing the source electrode, the drain electrode and the organic layer by performing chemical mechanical polishing (CMP), after the forming of the source electrode and the drain electrode.

13. The method of claim 8, wherein the organic layer has negative photosensitivity and the method further comprises: patterning the first and second holes using the organic layer as a patterning mask, before the forming of the source electrode and the drain electrode.

14. The method of claim 13, wherein the patterning the first and second holes comprises performing patterning using a 0.4% tetramethyl ammonium hydroxide (TMAH) solution as an etchant.

15. The method of claim 8, wherein the active layer is formed by an oxide semiconductor including one or more selected from the group consisting of Zn, In, Ga and Sn.

16. An LCD comprising:
a gate electrode which is formed on an insulating substrate;
an active layer which is formed on the gate electrode;
a first buffer layer and a second buffer layer which are formed on the active layer and are spaced apart from each other; and
a source electrode and a drain electrode which are formed on the first buffer layer and the second buffer layer, respectively,
wherein the active layer is formed by an oxide semiconductor including one or more selected from the group consisting of Zn, In, Ga and Sn, and the first buffer layer and the second buffer layer include indium zinc oxide (IZO) or indium tin oxide (ITO).

17. The LCD of claim 16, wherein the source electrode and the drain electrode include silver (Ag).

18. The LCD of claim 16, wherein the gate electrode comprises a triple layer including IZO/Ag/IZO or ITO/Ag/ITO.

19. The LCD of claim 16, further comprising:
a photosensitive organic layer which is formed on the entire surface of the active layer, except on the first buffer layer and the second buffer layer.

20. The LCD of claim 19, further comprising:
a data pad which is formed on the photosensitive organic layer and is connected to the source electrode; and
a pixel electrode which is formed on a level with the data pad and is connected to the drain electrode,
wherein the data pad and the pixel electrode include IZO or ITO.
